(19) United States
(12) Patent Application Publication
(10) Pub. No.: US 2021/0287166 A1
(43) Pub. Date: Sep. 16, 2021

(54) SYSTEMS, METHODS AND COMPUTER PROGRAM PRODUCTS FOR OPTIMIZATION OF TRAVEL TECHNOLOGY TARGET FUNCTIONS, INCLUDING WHEN COMMUNICATING WITH TRAVEL TECHNOLOGY SUPPLIERS UNDER TECHNOLOGICAL CONSTRAINTS

(71) Applicant: SPLITTY TRAVEL LTD., Rishon LeZion (IL)

(72) Inventors: Shay HOROVITZ, Rishon LeZion (IL); Eran SHUST, Rishon LeZion (IL); Avraham WORTZEL, New York, NY (US)

(73) Assignee: SPLITTY TRAVEL LTD., Rishon LeZion (IL)

(21) Appl. No.: 16/625,071

(22) PCT Filed: Jan. 24, 2019
(86) PCT No.: PCT/IL2019/050099

§ 371 Date: Dec. 20, 2019

Related U.S. Application Data
(60) Provisional application No. 62/621,604, filed on Jan. 25, 2018.

(51) Int. Cl. G06Q 10/08; G06N 20/00; G06N 5/04

(52) U.S. Cl. CPC G06Q 10/0835; G06N 5/04; G06N 20/00

(57) ABSTRACT

System, method and computer program product for managing communications e.g. with suppliers of computerized travel products e.g. via e-commerce; the method including all or any subset of: for at least one user's request for a computerized travel product e.g. vacation deal, using a processor to perform: predicting an optimal supplier for the user's request, from among plural suppliers, sending the request to the optimal supplier predicted by the predicting; receiving the request result e.g. from the optimal supplier and transmitting a response to the user.

### FIELD OF THIS DISCLOSURE

The present invention relates generally to travel technology and more particularly to presentation of computerized queries to servers in the realm of travel technology.

### BACKGROUND FOR THIS DISCLOSURE

Bid optimization techniques are known and are described e.g. here https://davinci11.com/bid-optimization-techniques/.

Black box testing is known and is described e.g. here https://link.springer.com/article/10.1007/s11081-016-9307-4.

Bayesian optimization is known and is described e.g. here https://en.wikipedia.org/wiki/Bayesian_optimization

Reinforcement learning is a known field and is described e.g. here https://en.wikipedia.org/wiki/Reinforcement_learning.

Q-learning is known and is described e.g. here https://en.wikipedia.org/wiki/Q-learning.

Hotel-metasearch engines are known and are described e.g. here: https://www.siteminder.com/r/hotel-distribution/hotel-metasearch/current-state-metasearch-can-hotel-find-real-value.

A system useful in conjunction with embodiments herein is described in copending “System and Method for Optimizing Utilization of a Population of Underutilized Physical Facilities Such As Tourist Facilities”, filed as PCT/IL2015/051249 on 23 Dec. 2015 and published as WO 2016/103265 on 30 Jun. 2016.

A more advanced system useful in conjunction with embodiments herein is described in copending European Patent Office application 15872103.5 on 23 Dec. 2015 and as U.S. Ser. No. 15/539,466 also on 23 Dec. 2015.

Another system useful in conjunction with embodiments herein is described in copending “Split Vacation Deal Generating Server And Efficient Split Deal Generating Methods” filed as PCT/IL2016/050813 and published as WO2017/017674 and also filed and published as European Patent 16829956.8 and US-2018-0204145.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented as appropriate.

At least the following embodiments are provided:
Embodiment A: A system, computer product or method for managing communications with suppliers; the system, computer product or method comprising all or any subset of:
operation a1: A server that receives requests for vacation deals from users using an Internet protocol (HTTP or API or other)
operation a2: Upon retrieval of a single request for a vacation deal, the server performs all or any subset of the following operations a3-a7, in any suitable order e.g. as follows:
a3. Obtain a list of suppliers that support said request (by location of user, by capacity, by look-to-book limitation or any other constraint)
a4. A deal goal function that returns a value that depends on a given goal. Examples of goals: “the cheapest deal price” , “the deal with most featured terms”, e.g. refundable, free breakfast etc.
a5. A Classification algorithm that is given a request for a vacation deal, is able to predict at least one supplier that may maximize said deal goal function.
a6. The server sends the request of the user to a service of the predicted supplier, and receives a price quote for that request
a7. The server returns the price quote of the predicted supplier to the user

### Optionally:

The Classification algorithm is substituted by a Probabilistic Classification algorithm, that is given a request for a vacation deal, is able to return an ordered list of suppliers, sorted by their anticipated return of the deal goal function.

A deal attractivity criteria. Examples of deal attractivity criteria: “at least 10% discount”, “deal is cheaper by at least 30% compared to the most expensive deal returned by another supplier that was examined for that deal so far”

The server, sending the user's request to each of the returned suppliers, serially (sequentially—one by one), according to the order of suppliers, returns by the probabilistic classification algorithm, and, upon each return, checks a stopping condition according to said deal attractivity criteria.

as in embodiment A, the server now returns the price quote of the predicted supplier to the user.

Typically, a user request may encapsulate multiple requests within it (e.g. a package deal composed of multiple deal ingredients such as hotel, flight, car rental), and per each of the encapsulated requests, the server performs all or any subset of operations a3-a7, in any suitable order.

Embodiment b: A system, computer product or method for managing communications with suppliers; the system, computer product or method comprising all or any subset of:

operation b1: A server that receives requests for vacation deals from users using an Internet protocol (HTTP or API or other)

operation b2: Upon retrieval of a single request for a vacation deal, the server performs all or any subset of the following operations b3 b10, in any suitable order e.g. as follows:
b3. Obtain a list of suppliers that support said request (by location of user, by capacity, by look-to-book limitation)
b4. A deal goal function that returns a value that depends on a given goal. Examples of goals: “the cheapest deal price”, “the deal with most featured terms, e.g. refundable, free breakfast etc.”
b5. A list of possible split indices for said. request the user request, having vacation deal date range, is broken up into all possible split permutations for 2 parts of said date range. e.g.: if deal starts at StartDate and ends at EndDate (K days in that range), the following are the possible splits with their indices: [1:(StartDate→StartDate+1, 2:(StartDate+1→EndDate), 3:(StartDate→StartDate+2, StartDate+2→EndDate), . . . , K-1:(StartDate→EndDate−1, EndDate−1→EndDate)]
b6. A Classification algorithm, that gives a request for vacation deal able to predict the split index that maximizes said deal goal function.
b7. The server, having the predicted split index creates 2 “virtual requests”—that are duplicates of the user request with modified dates—the first virtual request having the same StartDate of the user request and an EndDate that equals to StartDate+predicted split index; the second virtual request having the same EndDate of the user request and a StartDate that equals to StartDate+predicted split index+1.
b8. Another Classification algorithm, that per each of said 2 virtual requests in separate, is able to predict at least one supplier that may maximize said virtual request according to the deal goal function.
b9. The server, sending each of the 2 virtual requests to the matching predicted supplier, receives a price quote for each of the 2 virtual requests.
b10. The server returns a split deal (deal with 2 transactions, one for each of the 2 virtual requests) with the price quote that is the sum of the quotes received by the predicted suppliers of the 2 virtual requests.

### Optionally:

The Classification algorithm used to predict a supplier is substituted by a Probabilistic Classification algorithm, that gives a virtual request for a vacation deal able to return an ordered list of suppliers, sorted by their anticipated return of the deal goal function.

A deal attractivity criteria. Examples of deal attractivity criteria are: “at least 10% discount”, “deal is cheaper by at least 30% compared to the most expensive deal returned by other suppliers that were examined for that deal so far”

The server sends each of the 2 virtual requests to each of the predicted suppliers (each virtual requests with its single predicted supplier), serially (sequentially—one by one), according to the order of suppliers returned by the probabilistic classification algorithm, and upon each return checks a stopping condition according to said deal attractivity criteria per each of the 2 virtual requests in separate (If the stopping criteria was matched for only one of the 2 virtual requests, continue iterating on the suppliers of the other virtual request. Fully stop once the stopping criteria is matched for both virtual requests).

Continue according to embodiment b e.g., returning a split deal (deal with 2 transactions, one for each of the 2 virtual requests) with the price quote that is the sum of the quotes received by the predicted suppliers of the 2 virtual requests.

Typically, a user request may encapsulate multiple requests within it (e.g. a package deal composed of multiple deal ingredients such as hotel, flight, car rental), and per each of the encapsulated requests, the server acting according to the method of embodiment B (under “Upon the retrieval of a single request for a vacation deal, the server”).

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein.

Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The following terms may be construed either in accordance with any definition thereof appearing in the prior art literature or in accordance with the specification, or as follows:

target function : It is appreciated that the target function described herein may e.g. depending on the use case and/or context, be minimizing speed of response e.g. supplier likely to respond more quickly than other suppliers, supplier least likely e.g. based on history to suffer from technical problems, communications unavailability and so forth. It is appreciated that in practice, some suppliers but not all may use cache allowing those suppliers to respond faster, and some suppliers need to forward end user requests to other sources whereas others do not e.g. since they already have all the data required to respond. hotels may push updates using an API of suppliers in which case polling need not be performed. Another difference between suppliers which may motivate a target function prioritizing one supplier over another is that some suppliers may periodically e.g. daily provide the systems described herein with a current data base of price quotes. The Target function may also be minimizing cost of a travel product for an end-user of a system.
flight: may (as is apparent from the context) refer to a travel service by airline x, for flying from a to b, either with or without a stopover or layover, and may refer an end-user's request or order or flight search request to transit from origin a to final destination b (either directly or with connections).
Travel service providers: computerized web services or platforms, which allow travel services to be booked including providing a price, responsive to queries, for a desired travel service. Examples of travel service providers include Expedia, partners and collaborators of Expedia such as carRentals.com, and SilverRail airline websites. These providers typically communicate via an API with end-users such as travel agents and other computerized services such as GDS, travel web sites, travel price comparison services or other travel service providers. The end-user generates a flow of queries (responsively, the providers send back quotes) and also a flow of orders (e.g. purchases or bookings of travel services), responsive to which the providers make bookings. Some providers P are go-betweens, which communicate via APIs with other providers e.g. end-providers and pass on their quotes, to their (P's) end-users. This may be the case for all queries, or only for some queries.
Supplier: a travel service provider that allows its customers (through API) to perform bookings, as opposed to travel service providers that are limited to search/price comparison. Example suppliers include Hotel chains, EAN (Expedia Affiliate Network), Tourico, and Priceline.
Global distribution systems (GDSs) e.g. Amadeus, Sabre, and Travelport. Provide travel data from many service providers allowing agent end-users to make reservations without directly connecting with the many end-providers of travel (air, car, cruises, ferry, rail) and accommodation services e.g. hotel rooms. The GDS also typically includes an API to integrate reservation support into OTA booking engines thereby allowing the GDS's end-users to book or make reservations online. Typically, GDS is a costly channel hence chiefly is used to sell rooms en masse to groups or travel agencies. look-to-book ratio: % of surfers who visit an e-commerce website compared to those who actually make a purchase or book a service.
L2b limit: https://www.teknokraaft.com/techbulletin.aspx?nIId=46 says that:
Traditionally GDS does not charge you for the queries you send or the hits you make to their server using the conventional blue screen. When it comes to Web based connectivity, GDS charges you for a hit. This could be due to the fact that the conventional screen requires a trained person to work on it, whereas the web based system may be used by anyone who has a basic knowledge of travel industry. This could mean more hits than usual and could cause load on the GDS server and infrastructure. To avoid this or to limit this, a term called as L2B is used. An L2B of 250:1 simply means that one may look 250 times but should make 1 booking at least. One may send 250 queries to the server, and based on availability, schedules, fares etc. with multiple options, (carriers, time bands etc.) but if one booking is made, then no charge will be made by the GDS. For every hit or query exceeding 250 times to complete the booking, one is charged extra per hit. Even if this is 0.02 $ etc., for a large agency this could be a big amount at the end of a month if it is not managed properly.

GDS has varying levels of L2B. This means that wherever possible only light queries should be made to achieve one's goal, and heavy queries only when the situation demands it. This is where an experienced Travel Technology company may assist in controlling ongoing costs. Travel technology companies often claim that faster responses and better results are generated, with travel agencies going ahead with them, but are unpleasantly surprised upon receipt of their quarterly bills from ODS. An L2B of 500:1 is always better than 250:1.

OTAs: Online Travel Agencies. Typically, websites selling rooms human interaction, e.g. Booking.com, Expedia and Hostelworld. These allow end-users to compare rates, reviews, and availability of plural accommodation options, and book in a few clicks. Hotels typically pay a commission of approximately 15% to 20% every time they get a booking but they benefit from OTA by being more visible online since OTA's are large enough to invest in the online marketing needed to outrank searches made by traveler end-users on conventional search engines such as Google. Hotels' computerized systems typically log onto each OTA's extranets to update daily availability and rates, or to connect an OTA to a channel manager which then operates to automate or facilitate these updates.

Here and with regard to other entities mentioned herein, the specification for brevity refers to a networked computerized system which is serving an entity (such as an OTA or hotel) by the name of the entity. This “a hotel” or OTA, etc., refers in fact to the computerized systems respectively serving these entities respectively.

Split: a partitioning of a service into “split parts” e.g. plural parts, or legs, or durations. E.g. a hotel stay from 11 June-16 June is split into 2 parts: a one-day hotel stay on 11 June, and then the second part is a second hotel say from 12-16 June. Or, a journey by air from Israel to California is split into 4 parts or legs: Israel-Turkey, Turkey to France, France to New York, New York to California.
Markup: An amount added to the cost price of goods (for example—hotel room booking) to cover overhead and profit. May be presented as a value or as a percentage of the original cost price. Markup may include a cost at which a travel service may be commissioned from a particular end-provider and the same service's selling price as determined by the travel service provider which seeks to sell that service via, say, a price comparison website.
probability classification algorithm, Probabilistic Classification algorithm
e.g. as per https://en.wikipedia.org/wiki/Probabilistic classification
regular classification algorithm—a Classification algorithm or classifier that is non-probabilistic e.g. is not a probability classification algorithm
Query (or Request) or price quote query is intended to include HTTP/API requests sent or “fired” by the platform of FIG. 4a or 4b, to travel product suppliers of that platform, although (e.g. in the actual drawings of FIGS. 4a, 4b) the term “request” is also used, as is clear from the context, to describe requests coining from a human end-user user to the platform of FIG. 4a or 4b.
Quota: balance maintained in memory, e.g. by the platform of FIG. 4a or 4b, e.g. in cache 402, per each supplier in order to guarantee that the platform does not exceed or break that supplier's look 2 book policy. A possible value of such quota may be the ratio between the actual accumulated number of looks per relevant time unit (e.g. perhaps the supplier determines this per calendar month), as the numerator, divided by a denominator which is the actual bookings made by the platform of FIG. 4a or 4b via that supplier per the same relevant time unit. typically, this is normalized between 0 and 1. Then, the platform may be configured such that if the numerator is incremented by one indicating one more look added to the total looks by firing a query to that supplier, and the result of that value is larger than the supplier's Look-2-Book policy ratio—then the platform is configured to block that “look” request typically before the query is fired, because that supplier's look2book policy limits the ratio between price quote queries (looks) to their servers and the bookings that the platform of FIG. 4a or 4b actually makes, via that supplier.

### BRIEF DESCRIPTION OF THE DRAWINGS

FIGS. 1a-1e are diagrams useful in understanding certain embodiments.

FIGS. 2a-2d, 3a-3c are actual screenshots useful in understanding certain embodiments and advantages thereof.

FIGS. 4a-4b are simplified block diagram illustrations of embodiments of the present invention.

FIGS. 5a, 5b, 5d are formulae which may used by processors or servers integrated into certain embodiments.

FIGS. 5c, 5e are tables useful in understanding certain embodiments.

Methods and systems included in the scope of the present invention may include some (e.g. any suitable subset) or all of the functional blocks shown in the specifically illustrated implementations by way of example, in any suitable order e.g. as shown.

Computational, functional or logical components described and illustrated herein may be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit Technology) or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case some or all of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data may be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line, which is of any type or level or amount or category of volatility, differentiation, mutability, accessibility, addressability, capacity, performance and energy use, and which is based on any suitable technologies such as semiconductor, magnetic, optical, paper and others.

### DETAILED DESCRIPTION OF CERTAIN EMBODIMENTS

Certain embodiments are now described, which may he incorporated into or as a platform for ordering flights, or as a B2B service for flight providers that optimizes their offerings, or as a desktop solution for human travel agents since practically speaking, the search space in order to find better/cheaper flights is too big for human agents to scan.

Methods that are useful for managing communication with suppliers under constraints, flight price optimization and travel deals bidding, are now described. Typically, the methods are used for obtaining low Flight Price from existing computerized systems offering flight travel products via ecommerce.

### Reversed Origin Return Ticket Method

In this method, the system is operative to reduce the total price of a set of roundtrip-journeys , where there is a price difference between a round trip journey A>B>A and B>A>B. For example, one would like to have two round-trip journeys between locations A and B, where the first journey may start on January 1 and end on January 10, and the second journey may start on January 20 and end on January 30. In case more than one round trip journey is planned, orders may be performed such that the first order will consist of the first journey and will have the return date of the last return, and a reversed return (origin is B instead of A) journey of B>A>B will complete the missing flights. There is no change in the following flights: A>B, B>A, A>B, B>A. For example, the first journey may start on January 1 (where the origin of this flight is A, and the destination is B) and its return may be on January 30, whereas another journey may begin in the opposite direction from B on January 10, and its return may he on

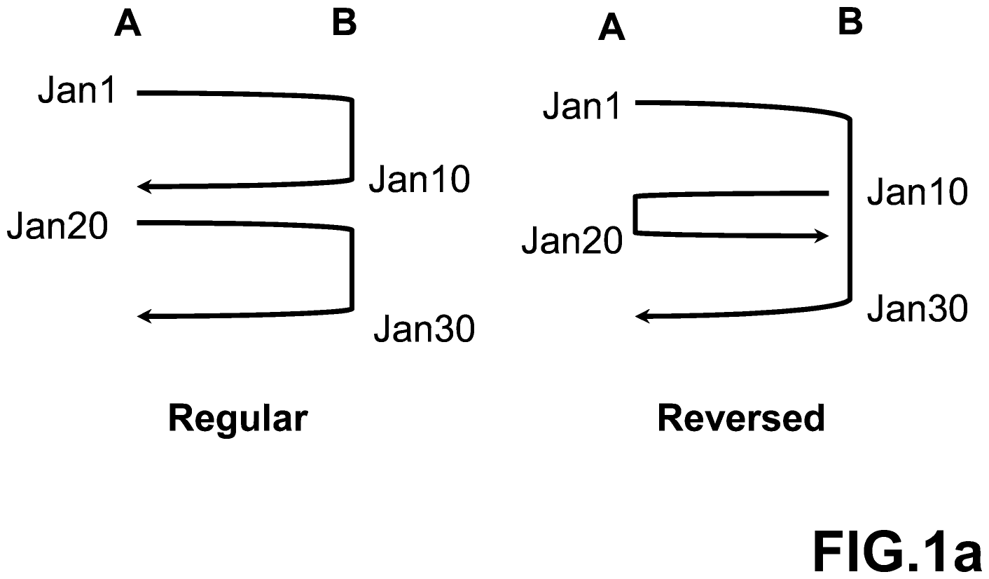

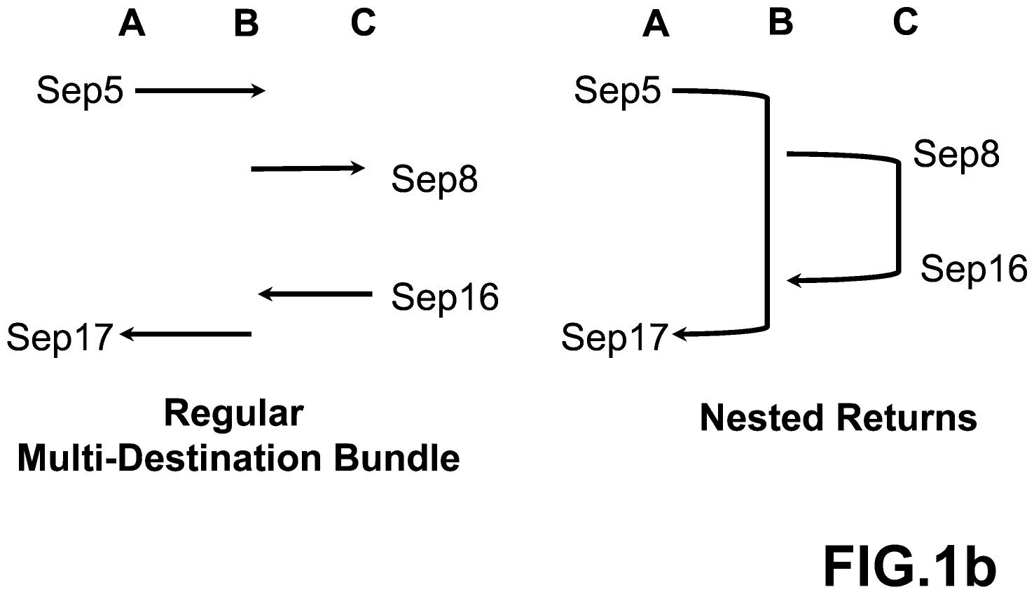

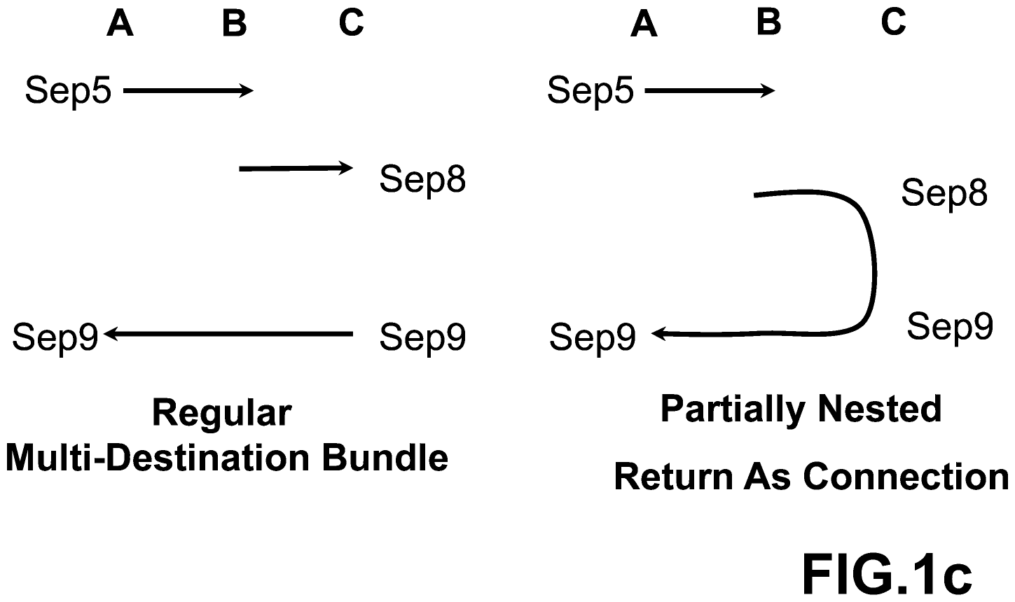

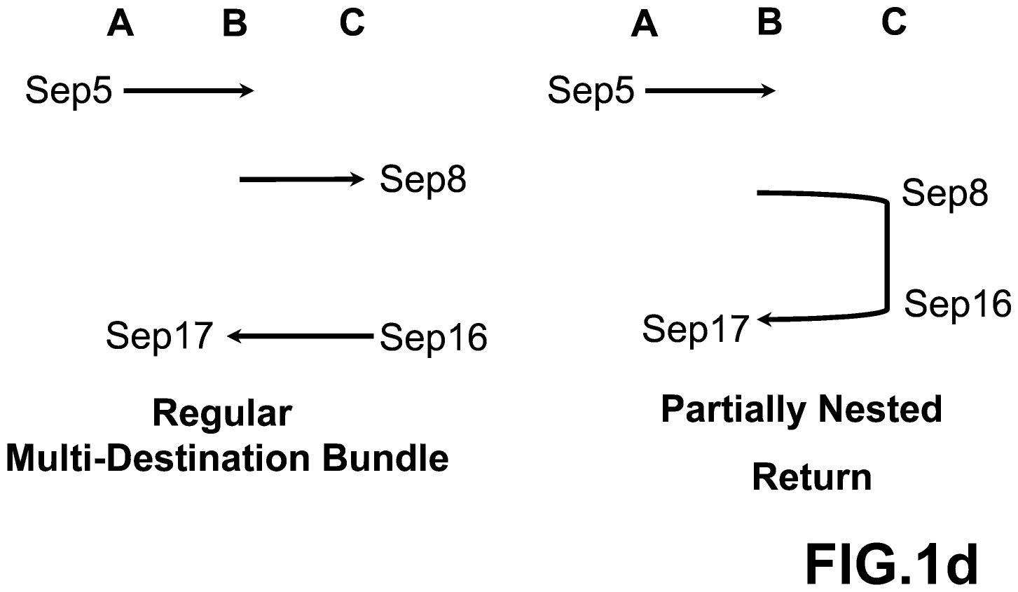

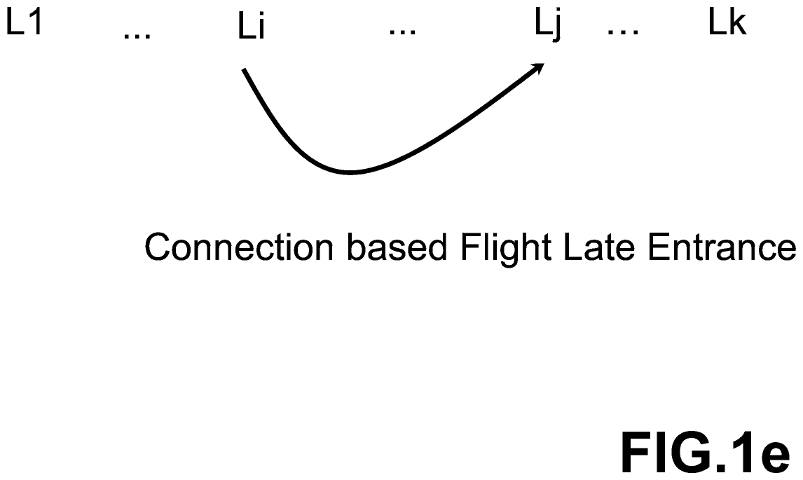

January 20 (where the origin f this flight is B, and the destination is A) e.g. as shown in FIG. 1a, for example, where A could be Tel-Aviv, and B could be Paris.

An actual example of the potential saving is as follows: The path A>B>A from June 1 to June 10 costs $1000 and the path A>B>A from June 20 to June 30 costs $900, and the total cost for both flights is $1900. But the path A>B>A from June 1 to June 30 costs $1000 and the path B>A>B from June 10 to June 20 costs $700, with a total price of $1700—constituting a total saving of $200.

In another embodiment, this method may be used for a one-way flight A>B and another round-trip B>A>B or even B>C>B, such that the total cost may be reduced by separating A>B, B>A>B to A>B>A, A>B, or instead of A>B, B>C>B, or separating to A>B>C (where B is a connection for example), C>B.

As non-limiting examples, A may be Tel-Aviv, B may be Paris, and C may be New York City.

### Nested Destinations Round Trips Ticket Method

In this method, the system is operative to yield multiple destinations in a nested fashion; for example: A flight from A to B on September 5, from B to C on September 8, returning from C to B on September 16, and finally returning from B to A on September 17.

Some websites allow to order multiple destinations as a bundle deal, yet in some cases it could be advantageous to perform the same orders as nested round trips and save, e.g. as shown in FIG. 1b.

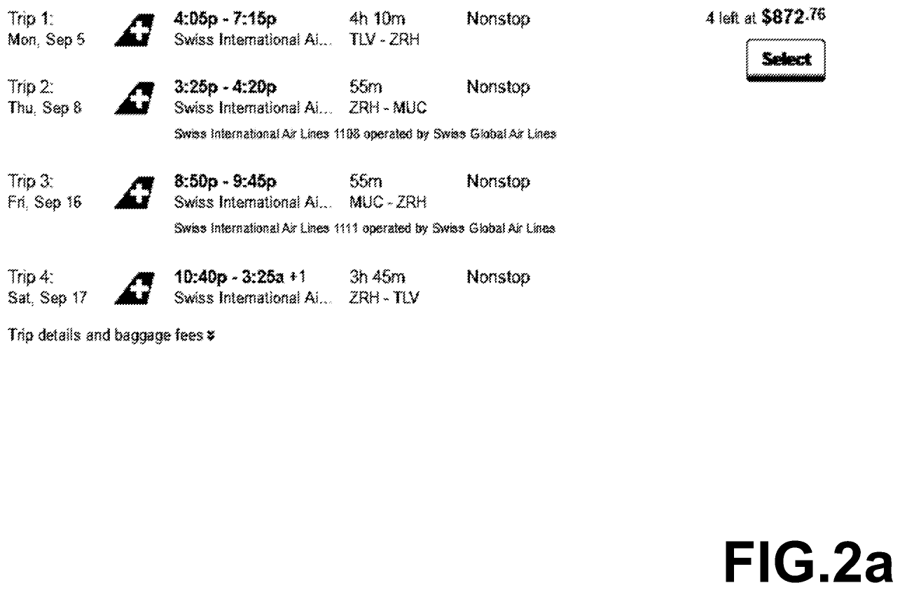

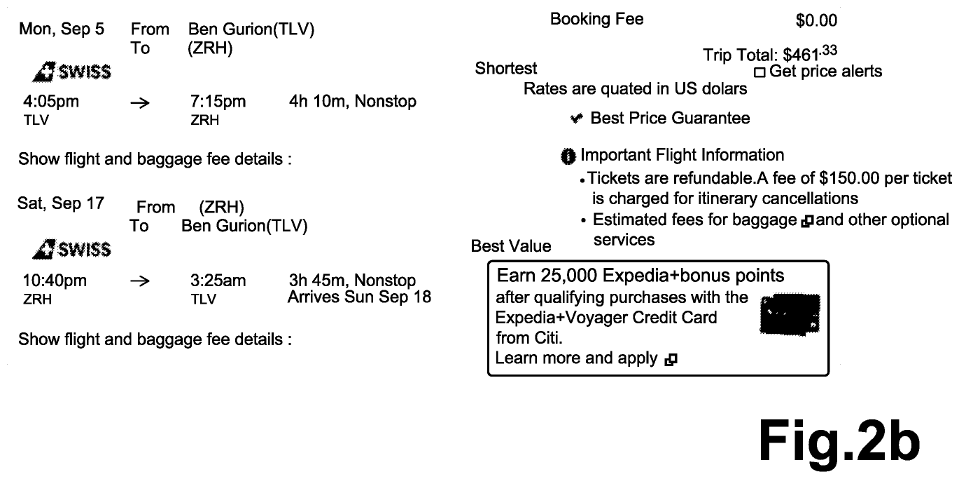

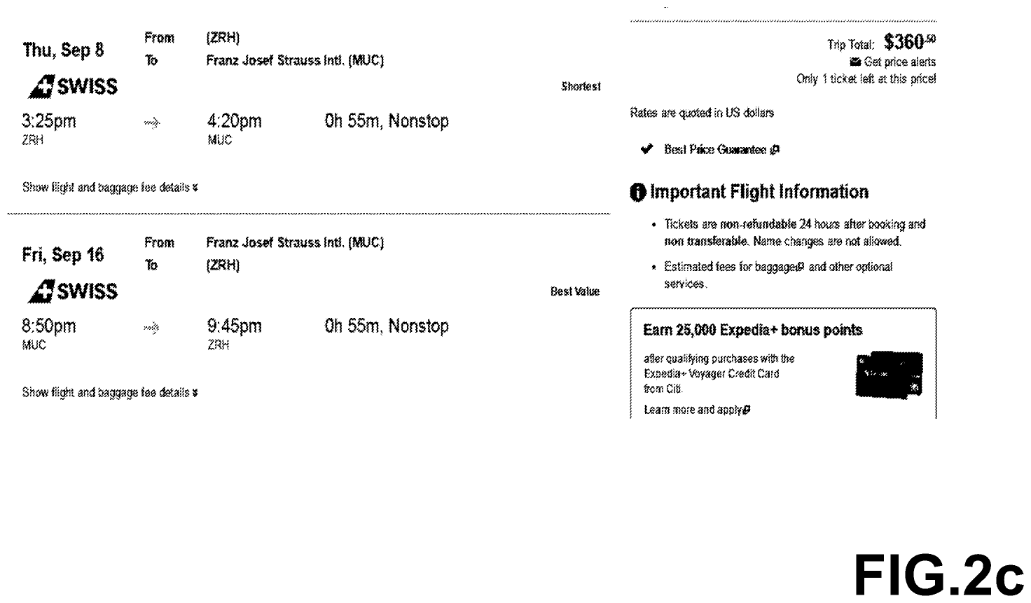

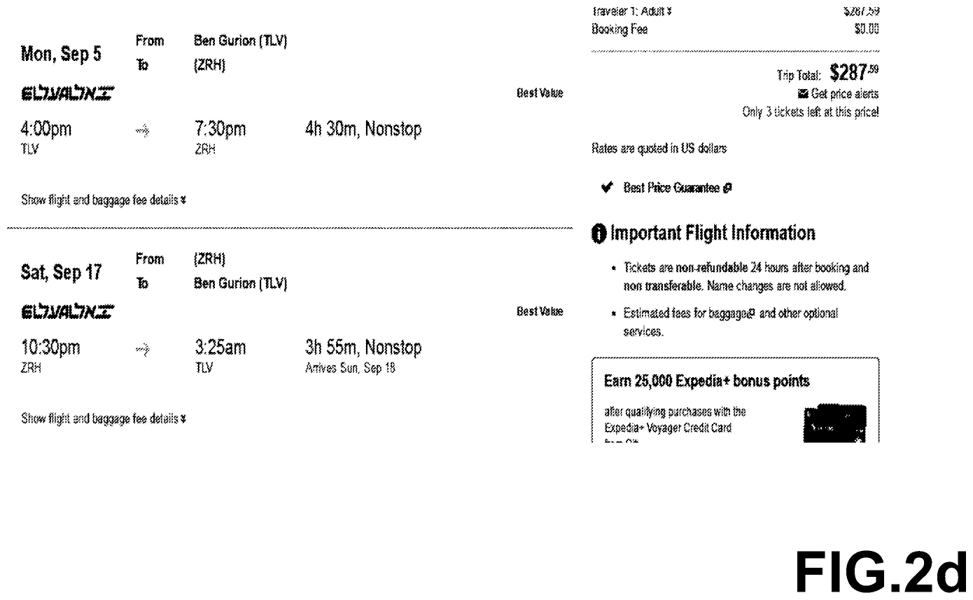

An actual example of Nested Returns on Expedia results of flight route: TLV-ZRH-MUC-ZRH-TLV, for the same flights is shown in FIG. 2a. An Expedia bundle: total $872 (lowest price in Expedia for the dates asked) is shown in FIG. 2b and in FIG. 2c.

Nested returns: total $821 (the sum of bookings depicted in FIG. 2b and FIG. 2c)—saving is thus 872−821=$51.
The usage of nested returns allows also to mix flight providers, while optimizing each return separately and save more. For example, the return trip TLV>ZRH>TLV may be replaced—instead of $461 of SwissAir as shown in FIG. 2h, $287 of El-Al, as shown in FIG. 2d, may be chosen, increasing the total saving, e.g. the saving instead of $51, $225=The difference between 872$ (TLV>ZRH+ZRH>MUC+MUC>ZRH +ZRH>TLV) and the sum of the following two return flights: $287 (TLV>ZRH>TLV using ElAl+$360 (ZRH>MLTC>ZRH using SwissAir).

Note that when a customer of Expedia asks for the price quote of this journey, he may actually get the quote of $872 e.g. as shown in the actual example of FIG. 2a.

In another embodiment the evaluation of each alternative may address not only the price, but also other considerations, including but not limited to: baggage fees, for example in transatlantic flights with additional internal flights, in most cases if one has a single order, there is no additional fee for the internal flight baggage.

Another embodiment addresses the case where a one-way trip is combined with a round-trip journey, as in FIG. 1c or in FIG. 1d.

Connection based Flight Late Entrance: In some scenarios, e.g. as shown in FIG. 1e, a flight journey that contains at least one connection (a sequence of at least 3 locations), may be offered at a reduced price compared to at least one subsequence of that journey. In this method, given a request for flight from location Li to location Lj, at least one sequenced journey (Ll> . . . Lk) may be returned to said request where a subsequence exists with source Li and destination Lj.

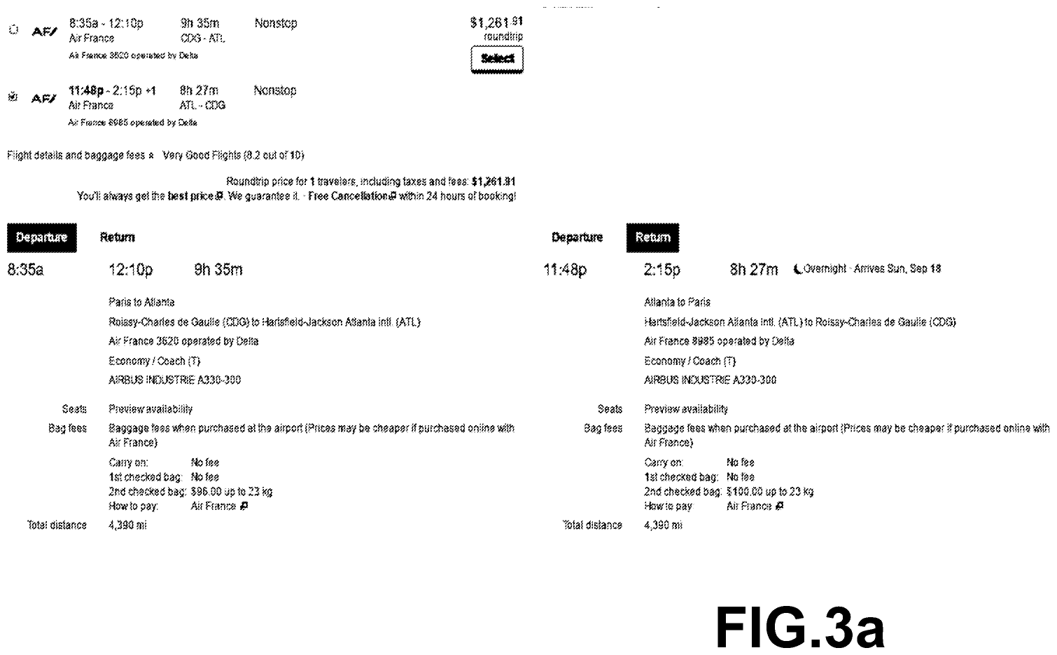

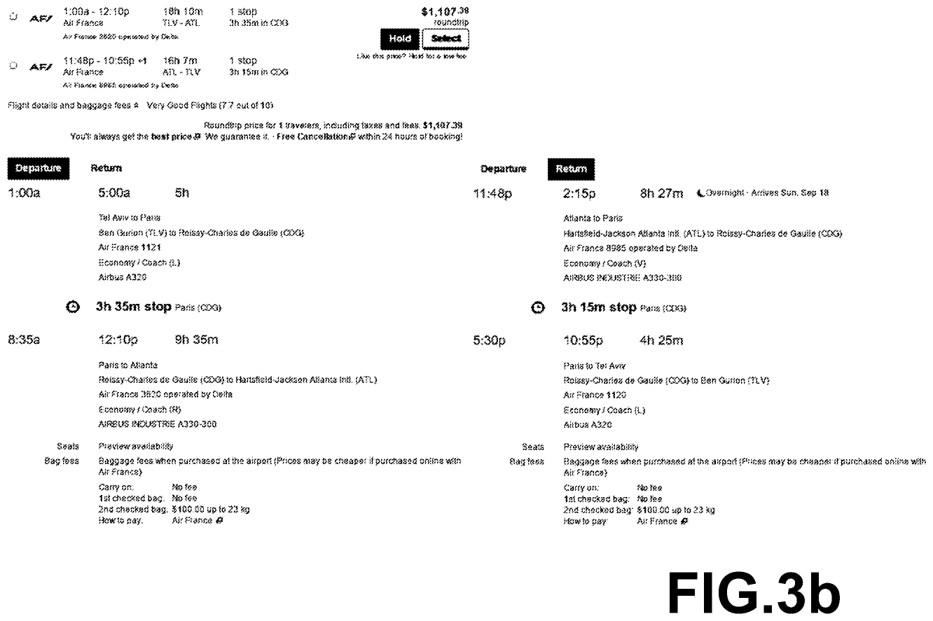

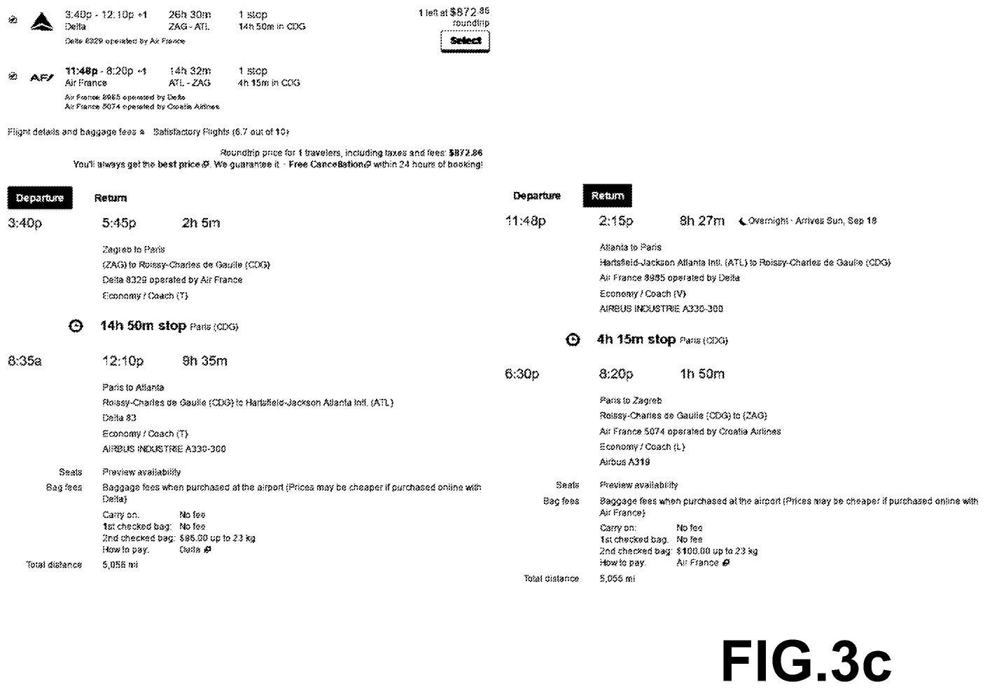

In one embodiment, it is possible that Li=Ll and/or Lj=Lk.
Example: end-user seeks to order a flight from Paris to Atlanta, on September 10-17.
According to Expedia this flight costs $12661.91, as pictured in FIG. 3a. An original Flight from PAR to ATL is shown in FIG. 3a.

Instead, a user may order a flight on the same dates from Tel iv to Atlanta (connection in Paris CDG on both sides) and save $154,52 on the same flight while actually only being on the leg between Paris and Atlanta and between Atlanta and Paris (not visiting Tel Aviv).

This saving is the difference between FIG. 3a ($1261.91) and FIG. 3b ($1107.39).

A connection Flight from TLV to ATL through PAR is shown in FIG. 3b.

Notice that if the same flight (this time code-shared between Delta and AirFrance) is ordered from Zagreb to Atlanta (through Paris) this would save $389.05; see FIG. 3c. This saving is the difference between FIG. 3a ($1261.91) and FIG. 3c ($872.86). In one embodiment, the method may be implemented by all or any subset of the operations (suitably ordered e.g. as shown) in the following process:
1. Given original request for flight from Li to Lj, compute Ci and Cj—where Ci is a list of locations sorted according to distance from Li (including Li), typically in ascending order e.g. locations closest to Li would he first (e.g. to enable a traveler to easily take a taxi to the Eilat airport from nearby Taba, or to easily travel from JFK airport to nearby Newark, rather than some further-away location) and Cj is a list of locations sorted according to the distance from Lj (including Lj) also), typically in ascending order e.g. locations closest to Lj would he first.
2. Perform at least some of the following operations (e.g. request price for at least some I's and j's; typically proceed in the order defined by the above-described sorting operation I):

For each location LCi in Ci
For each location LCj in Cj
   Request price for flight journey from LCi to LCj and store in DB.
It is appreciated that for at least some I, j pairs, the flight journey from LCi to LCj will pass through Li and Lj although there may he no way to explicitly limit the query to such l, j pairs.

Retrieve at least one journey (typically a flight journey from LCi to LCj which will pass through Li and Lj) having a price lower than originally requested journey Li to Lj
3. The DB of potential journeys may store historical requests of flight journeys combined with or without the entries added from step2.

If there is a no-show penalty for failing to complete certain legs of the journey, this may be factored into the price information, by the system.

Thus, according to one embodiment, a user interface is provided via which a user may stipulate a set (or sequence or list) of journeys or flights he wishes to undertake or order, typically including, for each such journey, an origin or source, time of departure, and a final destination and time of arrival. a processor is configured to find an optimal (using low cost/travel time/any other target function), including:

a. if among the list of flights, there exists at least one pair of (not necessarily consecutive) 2“mirror image” flights aka “flights with opposite directions” (e.g. FlightA.source=FlightB.destination AND FlightB.source=FlightA.destination), the processor may submit e.g. to a travel service provider such as booking.com or expedia, a round trip request for a price of a round trip including the 2 “mirror image” flights.

Alternatively or in addition,

b. if among the list of flights, there exists at least one pair of 2 flights wherein

FlightA.source=FlightB.destination AND FlightA.destination=FlightB.source AND common Location FlightA.destination has under 1 day of stay:—the processor may submit e.g. to a travel service provider such as booking.com or expedia, a request (source: FlightA.source, destination: FlightB.destination) to look for flights with connection/layover of Location FlightA.destination.

Alternatively or in addition,

c. per each flightX in the set or sequence or list the processor may submit e.g. to a travel service provider such as booking.com or expedia, a trip indirect (connection) request LocationNearFlightXSource
to FlightXDestination to look for a connection at FlightX.source.

It is appreciated that the travel service offered to the end-user may be one, in which the final destination is not the final destination defined by the user's set of journeys and/or the travel service offered to the end-user may be one, in which the initial origin (the origin of earliest flight) is not the initial origin defined by the user's set of journeys.

A server running a service that provides flight plans may be provided e.g. given an input set of flights (each with source and destination)—the service is configured to find alternative flight orders that may support the above mentioned cases. The service typically supports all or any subset of the following operations:

Referring now to FIG. 1a—in order to support that case the service will list all flights

([A→B,Jan1], [B→A,Jan10], [A→B,Jan20], [B→A,Jan30]) and compute all possible roundtrips for that list: e.g. [A→B→A,Jan1, return Jan 10], [A→B-→A,Jan1, return Jan 30], [A→B→A, Jan20, return Jan 30], [B→A→B,Jan10, return Jan 20]. Then per each permutation submit a query for price quote of that journey and then find a distinct cover (without any repeated journey/flight) that justifies a target function (minimal price, shortest flight times etc.).

Referring now to FIG. 1b, in order to support that case the service will list all flights [A→B,Sep5], [B→C,Sep8], [C→B,Sep16], [B→A,Sep117] and compute all possible roundtrips for that list: e.g. [A→B→A Sep5 return Sep17], [B→C→B Sep8 return Sep16]. Then, per each permutation, submit a query for price quote of that journey and then find a distinct cover (without any repeated journey/flight) that justifies a target function (minimal price, shortest flight times etc.).

An example of the journey described in FIG. 1b is depicted in FIG. 2a which shows the regular case (Regular Multi-Destination Bundle) and FIG. 2b and FIG. 2c which together present the alternative case (Nested Returns). The flight in FIG. 2c may be further substituted with the one in FIG. 2d which provides a better price from an alternative airline.

Referring now to FIG. 1c—in order to support that case, the service will list all flights [A→B,Sep5], [B→C,Sep8], [C→A,Sep9] and compute all possible connection based flights (where a connection may last for up to 2 days) for that list, (for example: [B→C→A, Sep8, Layover till Sep9 and return].Then per each permutation submit a query for price quote with at least one connection and then find a distinct cover (without any repeated journey/flight) that justifies a target function (minimal price, shortest flight times etc.) and that contains a connection of one day at location C.

Referring to FIG. 1d—this addresses the same rule of 1a using return flights in a subset of flights for the desired journey.

Referring to FIG. 1e—in order to support the case of a desired flight between Li and Lj, the service will list locations Vic(Li) which are locations in the vicinity of Li and Vic(Lj) which are locations in the vicinity of Lj—then submit connection based flight requests between each location. X of the set Vic(Li) to Lj having a connection in Li, and connection based flights requests for prices between Lj and each location Y of the set Vic(Lj) having a connection in Lj. Then, per each permutation, submit a query for price quote with at least one connection and then find a distinct cover (without any repeated journey/flight) that justifies a target function (minimal price, shortest flight times etc.). The traveler may skip X and hop on to the flight at Li or fail to take the flight from Lj to Y such that he gains his target (price/other) for the journey between Li and Lj. FIG. 3a presents the regular case described in FIG. 1e with the prices of direct flights whereas FIG. 3b presents a journey that covers the requested flight (Paris-Atlanta) using location X (Tel Aviv) at a lower price—hopping onto the flight only in Paris (missing the flight from Tel Aviv to Atlanta).

FIG. 3c represents another example of the case in FIG. 1a, this time using multiple airlines and a different location X (Zagreb) which provides even greater saving again hopping onto the flight only in Paris and missing the flight from Zagreb to Atlanta.

It is appreciated that if a platform described in co-pending patent applications mentioned herewithin (whose disclosures are incorporated herein by reference) supports handling of package deals (e.g. hotel+flight+car rental together), the above embodiments (e.g. as described with reference to FIGS. 1-3) may be used in conjunction with the platform, in order to optimize the flight component of the package deal.

Methods for managing communication with suppliers under constraints are now described in detail.

Certain embodiments are now described, which are useful in order to optimize Look2Book/call limit problems when working with suppliers. The embodiments may be part of (or a service for) a travel booking/search system or may be provided as a desktop application for human travel agents who can then, when they look for a deal and have multiple systems from multiple suppliers/providers/source, determine which system/interface to use for better results.

A supplier prediction method is provided; according to some embodiments, queries or requests are sent to suppliers serially rather than in parallel, in the event that the result or response returned by the supplier first queried, is not satisfactory. The method herein may be used inter ilia by:: an OTA working with multiple suppliers and serving requests from its users, a human travel agent working with multiple suppliers and serving his customers, a Travel Service Provider working with multiple suppliers and serving its customers, a GDS serving working with multiple suppliers and serving its users with an API.

In a use-case in which splits of a duration (e.g. of a 6-night stay, into 2 plus 4 nights, or 1 plus 2 plus 3 nights, etc.) are considered, 2 phase learning may be performed e.g. as described herein, where in the first phase the optimal index for the split is learned, and in the second phase the optimal supplier per each split part or per each sub-duration such as 1 or 2 or 3 or 4 nights, in the above example, is learned. In addition, a single phase learning for the use case of splits may be considered, where typically a learning algorithm is used to return the optimal split index and/or the optimal suppliers of each of the split parts.

Generally, in the field of computerized travel reservations, a query for a price of a hotel room, vacation rentals, accommodation rentals (AirBNB/HomeAway properties), flight, entertainment ticket, cruise and/or car rental may be sent to multiple suppliers (such as entities that supply results for travel queries, including hotels, hotel chains, hotel systems such as CMS, PMS, CRS), each having its own pricing policy. Naturally, the clients/customers of those suppliers (for example, OTA's such as Expedia.Com, Booking.Com, GDS such as Amadeus, Sabre or wholesalers such as Tourico, GTA, BCD) would like to compare prices between the different suppliers. Preferably, a client would like to submit each query to all or a portion or a pre-defined list of suppliers, and then be. presented with the best prices possible. Yet, suppliers are managing constraints and policies such as a Look to Book (L2B) ratio and calls limit (or both [like Expedia]) or limiting the rate or throughput of queries for example: up to a certain maximum amount of queries per minute/hour/day. Implicitly, this L2B ratio also prevents clients from sending each query to many suppliers, as it has to be careful not to violate the L2B ratio of each of its suppliers.

Thus, it may be advantageous to predict , in advance, whether a query to a given supplier has high probability to provide an attractive deal e.g. a deal with a competitive price or any other desired target function, compared to other available suppliers. This patent presents a method for managing communication with at least one supplier, where each supplier maintains a policy for its ‘Look to Book’ and/or call limit and/or minimizing throughput. The method comprises:
A Supplier Prediction Module
A Query Execution Module
A Supplier Policy Module

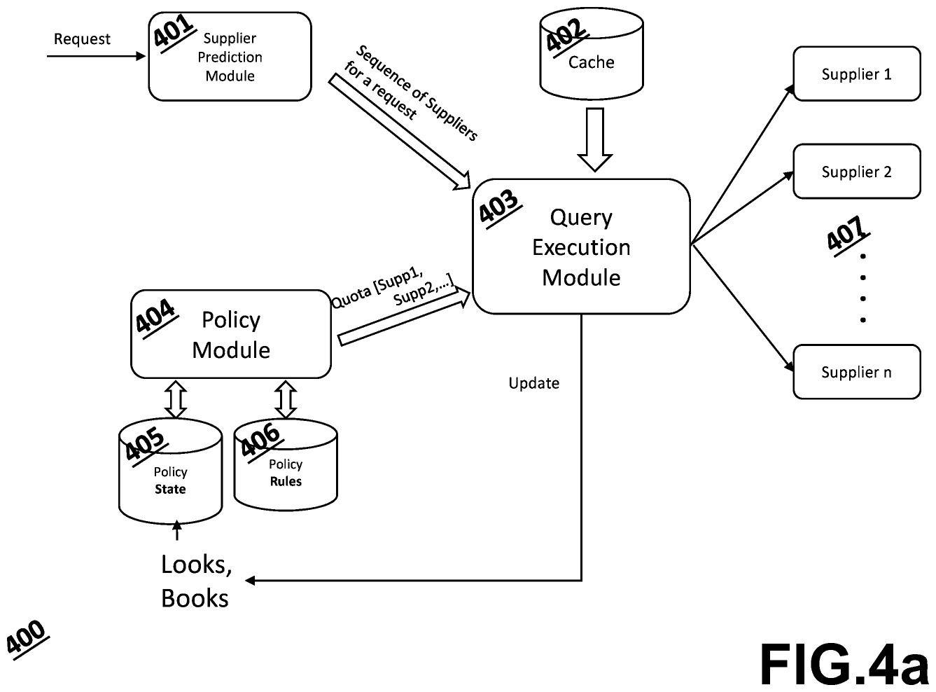

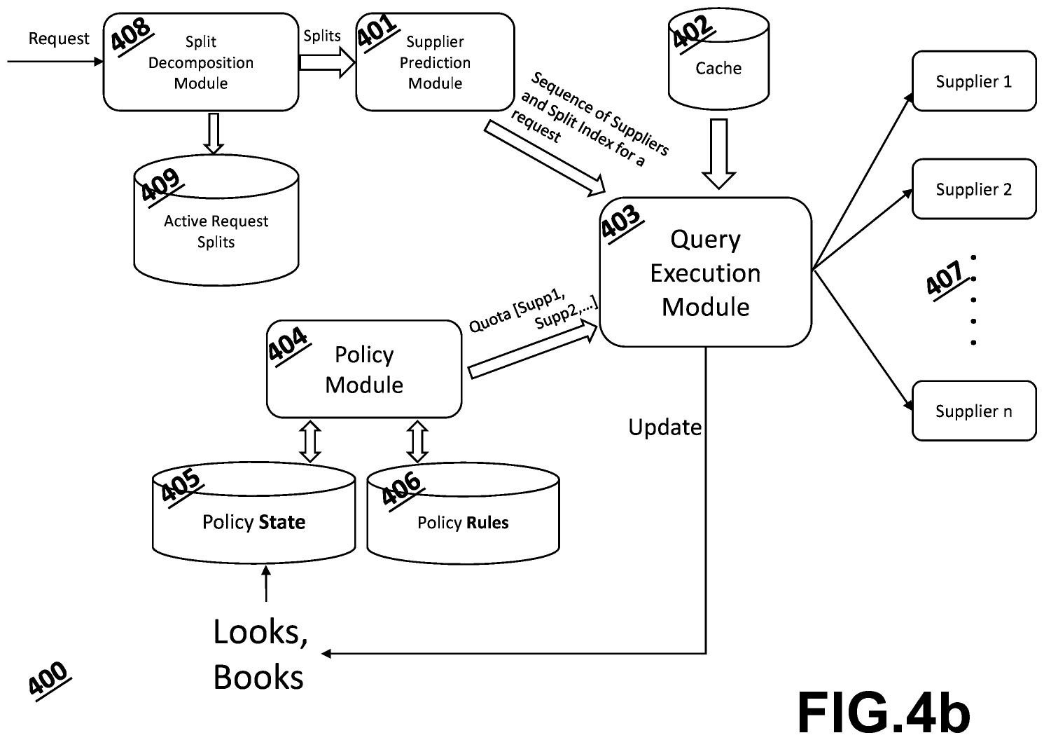

### Embodiment 1 (e.g. as illustrated in FIG. 4a)

Non split, Single request to a single supplier; thus predicting suppliers assuming, for simplicity, only one supplier per request

A method for managing communications with suppliers; the method comprising:
for at least one user's request of a vacation deal:
i. retrieving a list of suppliers that support the vacation deal request
ii. using a classification algorithm, predicting the optimal supplier for the user's request
iii. sending the request to the predicted optimal supplier
iv. receive the request result

### Embodiment 2 (e.g. as illustrated in FIG. 4a)

Non split, Serial Iterative process over time—sending a request to multiple suppliers serially. In this case, probabilistic classification may be used to sort the serial requests according to the likelihood/probability that this supplier is going provide a “good” deal (e.g. good price or any other suitable target function).

A method for managing communications with suppliers; the method comprising:
for at east one user's request of a vacation deal:
v. retrieving a list of suppliers that support the vacation deal request
vi. using a Probabilistic Classification algorithm in order to predict the optimal supplier for the user's request
vii. sending the request to the predicted optimal supplier
viii. receive the request result and evaluate whether attractive no
ix. If not attractive, continue the process with the next predicted supplier until an attractive deal is found or another policy condition has been met

Embodiments 1 and 2 are both non split embodiments; the system of Embodiment 2 may transmit more than one request, hence a probabilistic classifier is used since, first, all suppliers are sorted according to the prediction.

Embodiments 1 and 2 may be combined, using a configuration parameter—SINGLE_SUPPLIER (default is True) as a pseudo code such as:

Function Get_Best_NON_SPLIT_Response( USER_REQUEST)
{

ListOfSuppliersForRequest =

Suppliers.ThatSupport(USER_REQUEST);

If SINGLE_SUPPLIER = True then

{

PredictedSupplier =

Classification_Algorithm.Predict_Best_Supplier(

ListOfSuppl

iersForRequest ,

USER_RE

QUEST)

SentRequest = SEND_REQUEST(to: PredictedSupplier,

content:

USER_REQUEST)

FinalResponse = SentRequest.RECEIVE_RESPONSE( )

}
Else
{

SortedByProbabilitySuppliers =

ProbablisticClassification.Predict_andSortByPobability(

ListOfSuppliersForRequest,
USER_REQUEST)

```
  Iterator=0
  LABEL_BEFORE_SEND:
  SentRequest = SEND_REQUEST(to:
```

SortedByProbabilitySuppliers[Iterator] ,

content:

USER_REQUEST)

TemporaryResponse =

SentRequest.RECEIVE_RESPONSE( )

If (TemporaryResponse.CheckIfAttractive(Attractiveness

Condition) = False) AND

(Iterator < SortedByProbabilitySuppliers.SIZE)

{

Iterator = Iterator + 1;
GO_TO LABEL_BEFORE_SEND

```
  }
  Else
  {
```

FinalResponse = TemporaryResponse;

}

}

return FinalResponse

}

### Embodiment 3 (e.g. as illustrated in FIG. 4b)

Split , 2 phases—prediction for split index, 2^{nd} prediction for provider of each split

A method for managing communications with suppliers for split-based deals; the method comprising:
for at east one user's request of a vacation deal:
x. decompose the request to multiple optional splits
xi. retrieving a list of suppliers that support the vacation deal request per each split part
xii. using a classification algorithm, predicting the optimal split index for the said user request
xiii. for each of the split parts, using a classification algorithm, predicting the optimal supplier
xiv. sending the requests to the predicted optimal suppliers
xv. receive the request result

### Embodiment 4

Split, 2 phases with serial iterative, probabilistic.

A method according to embodiment 3, where in phase xii instead of using a regular classification algorithm, use a probability classification algorithm and then per each split part, use the method according to embodiment 2—iteratively finding the optimal suppler of that split.
Embodiments 3 and 4 relate to the case of splits 3 (e.g. as illustrated in FIG. 4b); these embodiments may use 2 classification algorithms rather than only 1. The first classification algorithm is configured to predict the best split index and the second is configured to predict the best supplier for each of the parts of the split. Embodiments 3, 4 may be combined as a pseudo code, such as:

Function Get_Best_SPLIT_Response( USER_REQUEST)
{

ListOfPossibleSplitPermutations =

FindAllSplitPermutations(

```
  USER_REQUEST.StartDate,
  USER_REQUEST.EndDate);
```

PredictedSplitIndex =
Classification_Algorithm.Predict_Best_SplitIndex(

ListOfPossi

bleSplitPermutations)

NewUSER_REQUEST_PART_A.StartDate =

USER_REQUEST.StartDate;

NewUSER_REQUEST_PART_A.EndDate =

USER_REQUEST.StartDate +

PredictedSplitIndex;

NewUSER_REQUEST_PART_B.StartDate =

USER_REQUEST.StartDate +

PredictedSplitIndex;

NewUSER_REQUEST_PART_B.EndDate =

USER_REQUEST.EndDate;

Response_A = Get_Best_NON_SPLIT_Response(

NewUSE

R_REQUEST_PART_A)

Response_B = Get_Best_NON_SPLIT_Response(

NewUSE

R_REQUEST_PART_B)

return (Response_A, Response_B)

}

### Embodiment 5 (e.g. as illustrated in FIG. 4a)

A “package” that may have more than one hotel booking or a hotel and a flight etc. per each part of the package the algorithm in 1 or 2 (and also 3 in the case of hotels only, since only hotels have a split 1.5 deal), may be used.

A method according to embodiment 1, where a package deal composed of multiple deal ingredients (such as hotel, flight, car rental) where, per each deal's ingredients, the method in embodiment 1 or embodiment 2 is used.

Embodiment 5 supports Package Deals (e.g. hotel+flight+rental+ . . . ) and provides that for each deal portion (aka part) in the package, the Get_Best_NON_SPLIT_Response algorithm may be used e.g. if the deal portion deal part is a flight or car). Also, for the accommodation portion of the deal (e.g. hotel) either Get_Best_NON_SPLIT_Response or Get_Best_SPLIT_Response may be used (typically, splitting is only for hotels).

### Embodiment 6

Combination of supplier prediction embodiment and methods described herein, for obtaining low flight prices from existing computerized systems offering flight travel products via ecommerce.

A method according to embodiment 1, where a package deal contains flights utilizing the flight optimization methods mentioned in this document as Methods for Flight Price Optimization.
Embodiment 6 combines Get_Best_NON_SPLIT_Response for flights with the flight product optimization embodiment of FIGS. 1a-1e, 2a-2d, 3a-3c herein. In this case, the function SEND_REQUEST In Get_Best_NON_SPLIT_Response may be overridden by a function that is aware of the methods_ (such as Reversed Origin Return Ticket Method, Nested Destinations Round Trips Ticket Method, Connection based Flight Late Entrance) presented in the flight product optimization embodiment of FIGS. 1a-1e, 2a-2d, 3a-3c herein.

FIG. 4a shows an example Supplier Prediction system. typically, upon each request, an evaluation is made by the Supplier Prediction Module. All or a portion of the request features are served as input to the prediction algorithm, that in turn decides on a sequence of suppliers sorted by the likelihood that each supplier may return a competitive offering for that request. Some suppliers may be filtered out according to any suitable filtering policy such as but not limited to:

a. maximum number of suppliers (for example, per a certain query or a specific region K suppliers may support that region, yet limit the search space to three suppliers out of K),

b. likelihood threshold for a supplier (for example, limit the list of suppliers to suppliers using a threshold that defines the minimum probability that a supplier is likely to provide a competitive price for the incoming query—such as suppliers that have at least 70% chance to provide a competitive price for the given query).

The sequence may be sent to a Query Execution Module, that executes the requests in a sequence (one by one or partially parallel) until an attractive offering has been found or another stopping condition has been met. An offer may be defined as attractive using any suitable criterion such as but not limited to each or any logical combination of the following: offer cheaper than the market price evaluated by cache. price comparison API, machine learning etc.), for such a room by a certain defined percentage, offer is cheaper by at least X% compared to the most expensive offer by other suppliers, etc.

The Query Execution Module updates the Policy Module on the queries that were actually sent, and the Policy Module maintains a quota per each supplier accordingly.

The Query Execution Module uses that quota information of each supplier in order to decide whether a query should be blocked and not be transferred to a supplier—in order to prevent a case of violating the supplier's policy/constraints such as its Look to Book policy or under the call limit policy or minimizing the throughput or other policy.

The Supplier Prediction Module may be implemented in the following ways:

Case of a single predicted supplier: provide all input features aka predictive parameters/variables (for example, for hotel queries may include: city, date of arrival, nights to stay, number of guests) to a regular classification algorithm having a label range that is defined by the set of optional suppliers. The learning classifier algorithm (for example: SVM, J48) is provided with a training set of historical data where per each query the supplier with the best price is set. Upon each query, the classifier will select the optimal supplier according to the trained model.

Case of multiple predicted suppliers ordered by priority: In this case an OTA or other system may use a Probabilistic Classifier that may provide the probabilistic outputs of the labels such as in Platt Scaling by learning a Logistic Regression model on the scores (published in “Probabilistic Outputs for Support Vector Machines and Comparisons to Regularized Likelihood Methods”, John C. Platt, and presented as LibSVM option-b) and then the resulted probabilities may be sorted, launching the requests to said suppliers in that order. Another method to present the probability of the classes is to perform Isotonic Regression (published in “Transforming Classifier Scores into Accurate Multiclass Probability Estimates”, Bianca Zadrozny, Charles Elkan).

FIG. 4b illustrates an example system for Split-Based Queries of Supplier Prediction. In another embodiment, for the case of hotel rooms queries (or flights or car rental and etc.), a split-based reservation may be relevant where a reservation for a hotel room on a specific date and for a given stay may be decomposed into a set of two or more splits that together cover the originally requested stay. in this case it is preferable that the prediction covers not only the supplier, but instead provides a mixed prediction that contains the supplier with the best possible split (that provides the highest discount) for that query.

This may be achieved by training a Probabilistic Classifier with a paired label of [supplier split index] (rather than just having one label per supplier e.g.). the split index, here and elsewhere, typically comprises any unique identifier of a given split such as the split of a 6-night hotel stay to one night, then 3 nights, then 2 nights. Thus, the number of classes is typically the product of the number of suppliers and the number of splits. it is appreciated that a “regular” or deterministic classifier typically comprises a processor configured to operate a rule, or function, that assigns to a sample x a class label 5/, where the samples come from some set X (with features such as DayOfWeek, month, number of requested nights, requested room type etc.) and the class labels form a finite set Y defined prior to training.

The samples typically comprise historical queries+the best Supplier/SplitIndex/Suppliers of each split part+SplitIndex per query—for example: a sample query for the case of Supplier prediction may be: DayOf Week:Sunday, Month: March, RequestedNights:5, RoomType:Double. The label for that query depends on the responses received. By way of example, say that Supplier A responded with $500, Supplier B with $400, Supplier C with $600 so the class label for this case may be “SupplierB” which was the cheapest. Each sample is a single query. The ML classification algorithm may take all the samples (each containing features of a single query and its class label best provider) and may generalize a computational relation between the samples X and the class labels Y.

In contrast, a probabilistic classifier typically comprises a processor configured to compute conditional distributions which assign probabilities, whose sum is typically 1, to all y for a given x. Deterministic or final classification of x may then be performed by the processor using any suitable technology such as the optimal decision rule to select a class or label to assign to x.

The data may be assembled from (historical queries and their responses, stored in computer storage available to the system. Any suitable what sw tools maybe be used such as but not limited to ml libraries such as, say, scikitlearn, mlbase, ml tools such as weka; for most tools a csv format is supported; use arff or other formats. Data stored may include query parameters and, in association therewith, responses thereto.

In another embodiment, for the case of hotel room queries (flight, car rental and e it may be advantageous to allow a split based reservation where each split may be booked through a different supplier. This may be implemented in the following ways.

1. Multi Step—in the first step train a classifier to learn the optimal split index of that query, and then for each split part—train another classifier to learn the optimal supplier of that split (using the method mentioned above with any classification algorithm).
For example, if the query is for a hotel room for 5 nights, on Friday Dec. 5 in NYC—then the first classifier will output the split index that is likely to have the cheapest offer. Then for each of the two parts of the split, another classifier will output the supplier ID that is likely to provide the cheapest offer for that split part.

2. Single Step Using a Probabilistic Classifier where training is performed on a “composite paired” (e.g. 3-component rather than 2-component) label of multiple suppliers: [split index, supplier of split part a, supplier of split part b]. For example, an output of such classifier for a given query of 5 nights stay may be [3, 9, 5] which means that the best expected split deal is of split index 3 (3+2 nights), the first 3 nights with supplier id=9 and the last nights with supplier id=5. In another embodiment, for the case of package deal combination (Ho el+Flight/Flight+Hotel+Car/Flight+Car/Hotel+Car/other combination) it may be valuable to select the optimal supplier for each of the package deal parts. This may be implemented using the same methods mentioned above, each deal part separately.

It turns out that practically speaking, there are a great many possible combinations of the possible predictive variables (e.g. of variables such as stay duration, day of week, day of month, season). One possible combination, say, might be “last Friday of the month” which causes complications due to the existence of Look-2-book limitations. thus, supplier prediction as described herein is practically speaking greatly advantageous.

It is appreciated that the supplier prediction embodiments described hereinabove, may be used as an alternative or modification or improvement of co-pending patent application mentioned herewithin e.g. if supplier prediction module 401 is added to FIG. 1 of the co-pending application e.g. as shown in FIG. 4b herein. However, the supplier prediction embodiments is not limited in its applicability to platforms which, like those described in co-pending patent applications mentioned herewithin, handle split-deals. Instead, the applicability of the supplier prediction embodiments herein may also be applied to platforms which also or only handle “non split” deals e.g. as shown in FIG. 4a. Also, it is appreciated that the supplier prediction module 401 of FIGS. 4a, 4b may implement any of the methods described herein for managing communication with suppliers under constraints, and any of the supplier prediction embodiments described herein (e.g. single or multiple predicted supplier; single or multiple step training of classifier, selection of optimal supplier separately for each deal part, etc.).

Methods for Travel Bid Optimization are ow described in detail.

These methods may be integrated within a travel solution that works with services such as trivago that requires bidding or may be implemented or performed by as an automatic system or desktop solution for a human operator who sets daily bids.

According to certain embodiments, Reinforcement learning or black box optimization algorithms are used to optimize bidding on a hotel-metasearch engine—such as but not limited to Trivago, Google Hotel ads, TripAdvisor, Kayak.

The reinforcement algorithm implementation may be taken from an existing software library such as https://github.com/dennybritz/reinforcement-learning.

The software-implemented algorithm is then activated for bidding optimization on the hotel-metasearch engine by parameterization e.g. by adding code that suitably defines the Reinforcement algorithm's states, actions, reward function/s and learning rate/s.

Each State may be defined as an ordered pair of current Bid and current Markup values.

An Action may be defined as Increment/Decrement f control parameters and may include, say, Inc_Bid_By_5%, Dec_Bid_By_5%, Inc_Bid_By_10%, Dec_Bid_By_10%, Inc_Markup_By_5%, Dec Markup_By_5%, do not increment and do not decrement e.g. 0% increment/decrement, etc.

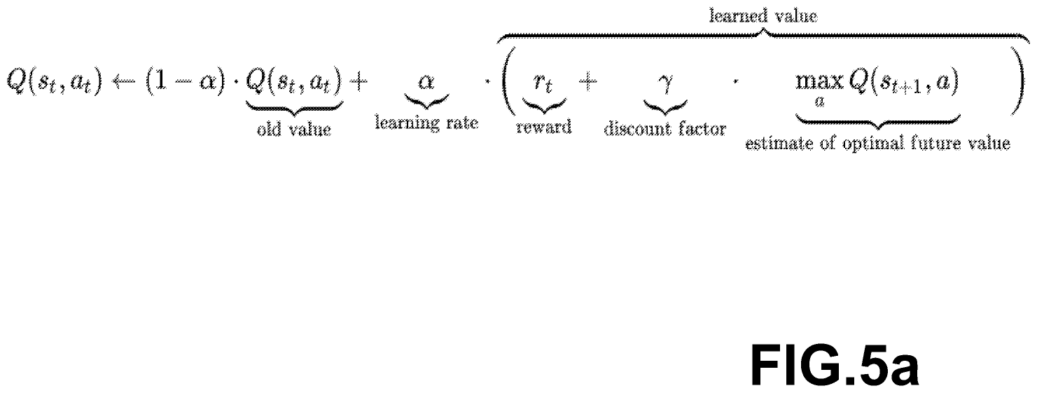

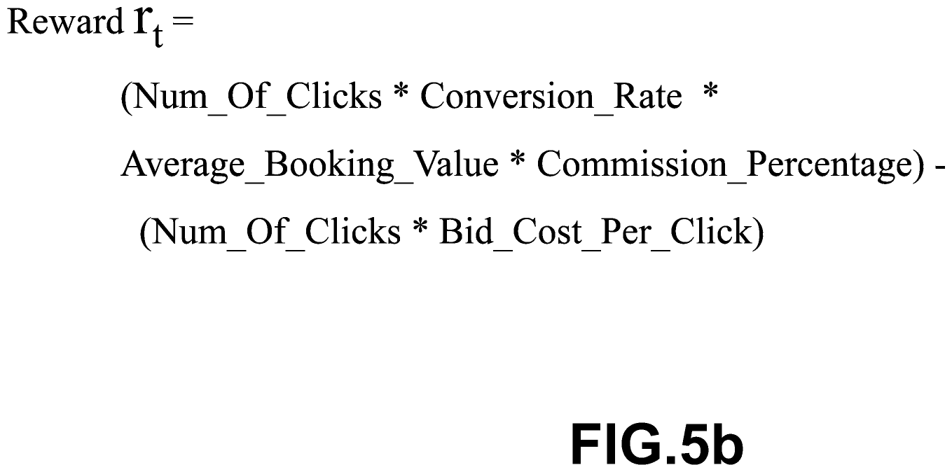

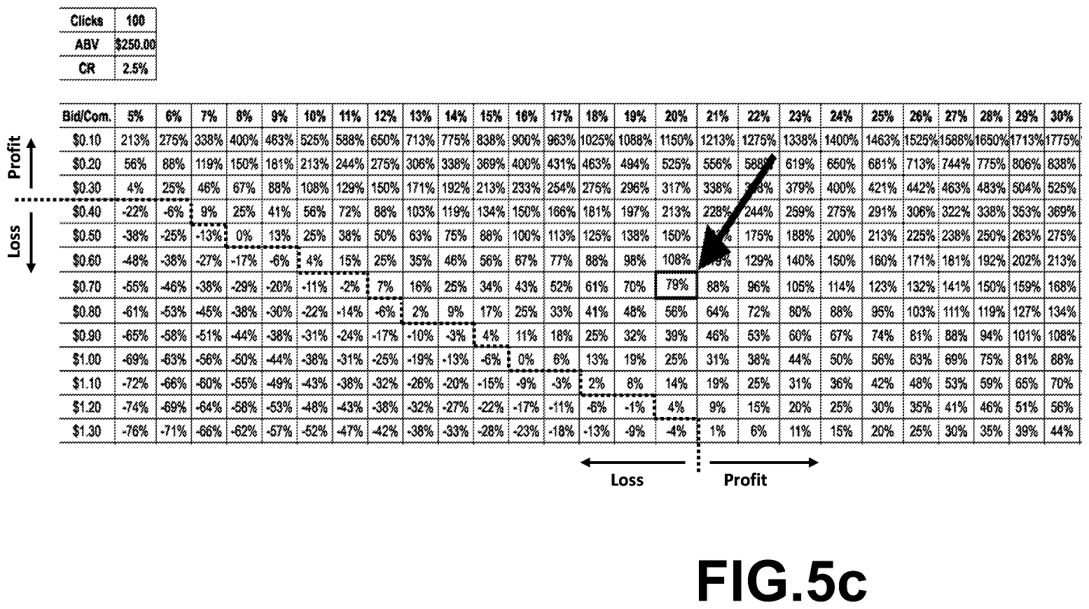

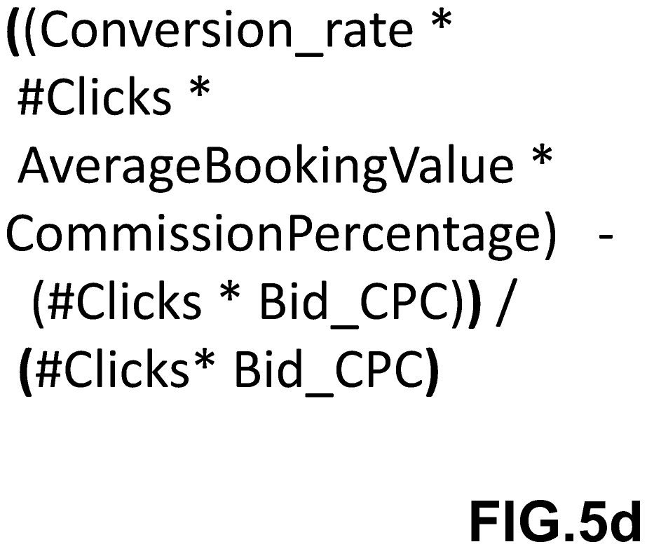

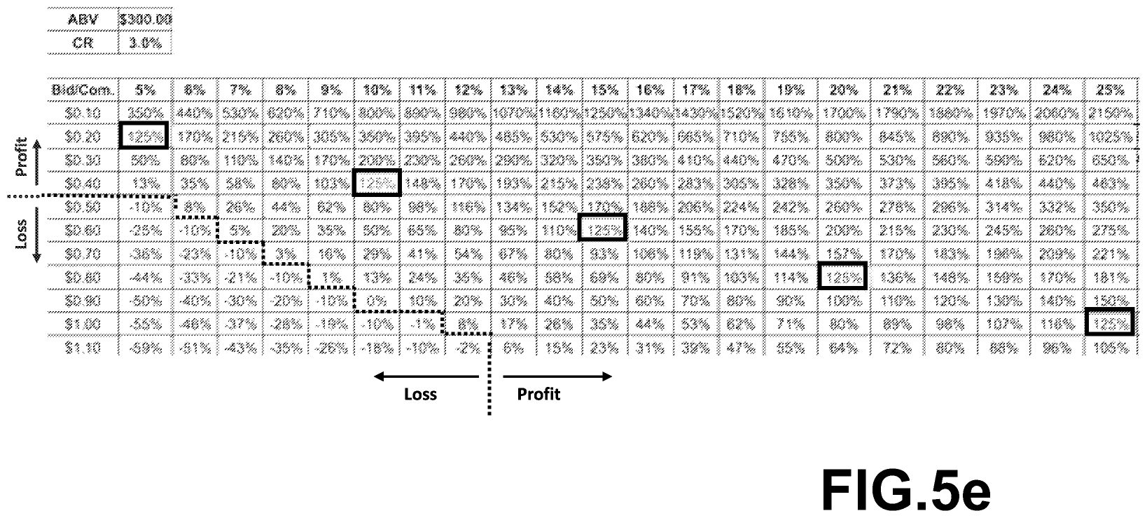

A reward function that serves as a reward for each selection of state and action may be as described herein. for example, the Reward rt of a given (e.g. last) iteration may be based on a formula such as that of FIG. 5b, that computes the success rate of that iteration.

Defining the learning rate may be achieved by solving an optimization problem e.g. by trial-and-error based experimentation with plural learning rate values until a learning rate is found which is “good enough” e.g. improves a profit. Or, use an optimization algorithm such as Gradient Descent, Adam, Adagrad, Adadelta, RMS Prop and Momentum, or Bayesian (black box) optimization) algorithm to choose a learning rate, typically using maximization of profit as a stopping-criterion.

A particular advantage is that the platform using the above algorithms for optimizing bidding on the hotel-metasearch engine then becomes a particularly efficient single provider of deals selected from among the many in the hotel meta-search engine.

For black box optimization algorithms, any suitable optimization suite may be used. a function may be defined that ranks the result of the output proposed by the black box (e.g. the profit). a success criteria may reflect e profit which may for example be computed wing the formula of FIG. 5b.

Also, the parameters that the black box may output are defined for the software implementing the black box optimization algorithm e.g. that the black box optimization algorithm outputs an ordered. (Bid, Markup) pair.

According to certain embodiments, each and every ordered (Bid, Markup) pair used to date (either as output of an algorithm or manually) may be stored in a table/database such that: per each pair of bid and markup values (also named parameters in optimization suites) used for a given time period for the metasearch engine, the average daily (say) profit (also named “target” in optimization suites) in that time period is stored. Then, at least once or on occasion or periodically e.g. every 24 hours—the black box optimization algorithm (for example—a Bayesian Optimization algorithm) is launched on the data of that table, and outputs a new pair of Bid and Markup values. That pair is used as input for the bidding API of the metasearch engine. Over the next 24 hours the server collects the daily profit and adds to the table a new entry of the last algorithm output of Bid and Markup and the daily profit.

A bid optimization server which may be provided per hotel, is described here, which, typically upon each bid step or where a bid is about to be made (either manually or automatically; this may (be programmed to) occur periodically e.g. daily or on occasion configured to provide optimal bid and markup parameters that serve as input for a computerized bidding process. For example, hotel MetaSearch services such as Trivago operate a bidding mechanism using an interface or an API . The providers that would like to appear in response to user requests at Trivago (say), supply a pair of bid CPC and room prices per hotel room. For example: for NY, Hilton 5^{th} avenue hotel, on Jan 1^{st}—BID CPC $0.5 and room price is $200 per night), such that a target function is maximized. A typical target function is the revenue of the organization served by the bid optimization server.

The following terms may be defined as follows:

1. ABV—average booking value (or total transaction value) or average price that the customer pays for a booking. This parameter is an input for the bid optimization server; typically manually entered by a human expert user.

2. CR—conversion rate, is the percentage of bookings the organization gets get out of the total clicks (could be also percentage if bookings out of total impressions/users and etc.). This parameter is also an input for the bid optimization server. For example, if the organization's computerized bookings log indicates that he organization gets 4 bookings out of 100 clicks, the CR will be 4%. The CR may be either computed based on historical data (such as last 24 hours, last week, or some other window) or predicted based on historical data e.g. using a time series algorithm, where the historical number of bookings and clicks and additional parameters such as day of week, city, is holiday or other may be set as input to the prediction algorithm, and the algorithm predicts the next day number of bookings and clicks.

3. Bid CPC—is the average bid in USD (or other currencies) that the organization pays for each click, typically to the organization's meta-search partner (such as Trivago).
A click may comprise an event in which an end-user clicks on a an OTA proposal within a meta-search website, and being redirected into the OTA's website. This is an output of the bid optimization server, that may be forwarded manually or automatically to the meta-search bidding mechanism using its bidding user interface or API. Commission—the amount of revenue in percentage that the organization earns from the travel deal (for example—the revenue of the OTA from booking a hotel. This number should be computed by the server of the OTA). This parameter is an input for the bid optimization server. For example, if an OTA buys the hotel reservation from the supplier at $80 and sell the hotel reservation to a customer for $100, its revenue is $20, which is 20% out of the total transaction value ($20/$100). This is an output of the bid optimization server, that may be forwarded manually or automatically to the bidding service, and may be added by the O′I′A that uses said optimization server to the hotel room price when sending hotel room prices to the meta-search server—in which case the bidding service gets a parameter representing the final price of the room including commission.
   The target function to be maximized by the bid optimization server is the ROI that is computed using the following formula:

### ROI=([CR*ABV*Commission]−Bid-CPC)/Bid-CPC

For example, if

### CR: 3%

### ABV: $300

### Commission: 20%

### Bid-CPC: $0.8

### ROI=([0.03*300*0.2]−0.8)/0.8=1.25≥125%

How the system/client that utilizes the Bid Optimization server computes its input parameters: These four parameters may be computed as follows:

1. ABV—may be computed based on historical data, generated either manually by the ( )A that registered the MetaSearch service or automatically by the OTA server (and OTA such as Booking.com registers to a MetaSearch service such as Trivago, so that users looking for hotels in Trivago.com will get price proposals from Booking.com. The OTA server can take all historical bookings that were originated by users that used the MetaSearch service and compute the ABV) Some examples:
Average/Median of bookings for the same hotel, the last X days
Average/Median of the last X bookings from the same hotel
Average/Median of the last X bookings from the same hotel and the same deal type (same in one or more of the deal parameters such as: cancellation policy, board type, room type and etc.)
Average/Median of the last X bookings from similar hotels (in terms of area, star rating, price range, chain etc.).
Using prediction capabilities in order to predict the transaction value.
Predefined by the OTA platform, and will be enforced by offering only deals which meet this ABV.

2. CR the conversion rate may he computed by the following methods:
Average conversion rate (number of bookings divided by the number of clicks) for the same hotel, the last X days
Average conversion rate from the same hotel and the same deal type (same in one or more of the deal parameters like: cancellation policy, board type, room type and etc.)
Average conversion rate from similar hotels (in terms of area, star rating, price range, chain and etc.).
Using prediction capabilities in order to predict the expected conversion rate.
Using the standards CR in industry from other OTA's for example)
   How may Bid Optimization achieve optimization of the target function and yield output ([BidCPC, Commission] per hotel)?

Various methods, options and triodes are now described; these may be provided together or in any subset.

One method or option or mode is Predefined CR & ABV mode.

In this mode, method or option, the bid CPC along with the commission, may be computed and determined by all other parameters. Assume the OTA would like to have a ROI of 125%, once the OTA have the CR and the ABV, the range of Bid CPC and commission may be set. The Bid CPC may be set for live requests on a daily basis or other periods (depends on the meta-search partner).

If the goal is to increase traffic: take the (Bid-CPC, commission) pair with the lowest Bid-CPC

If the goal is to increase revenue, taking the highest Bid-CPC in order to increase the number of clicks and bookings accordingly (the higher the Bid-CPC the more bookings the OTA get).

For example, re-using the above example:

CR: 3%

ABV: $300

Commission: 20%

Bid-CPC: $0.8

ROI=([0.03*300*0.2]−0.8)/0.8=1.25≥125%

In order to get to a ROI of 125% we may use one of the following 5 pairs; see the

5 bolded cells in the example table of FIG. 5e (by the server of the OTA):
Bid-CPC of $0.2 with 5% commission
Bid-CPC of $0.4 with 10% commission
Bid-CPC of $0.6 with 15% commission
Bid-CPC of $0.8 with 20% commission
Bid-CPC of $1.0 with 25% commission
others.

### Black Box Bid Optimization

In this method or mode or option, the server may utilize a black box optimization algorithm, that does not require the objective function's derivatives to be known (an optimization algorithm is searching for input parameters that will maximize/minimize the return value of a certain function. For some problems the function is given but may be too complex to evaluate its maximum using standard methods such as using the function derivative. Yet in the bidding problem, the function of the bidding system is not known for the bidders—and this scenario is called black box), in order to control the bid and the markup. Initially (optional) a set of random trials with ranging bids and markups is performed. Upon each trial, the said selected bid and markup are served to the bidding service (for example a hotel meta search service such as “trip advisor” or “google hotel ads”) and after a predefined time period, a success criteria value is computed based on performance features. For example: a success criteria may reflect the profit—which may be computed by:

(Num_Of_Clicks*Conversion_Rate*Average_Booking_Value* Commission_Percentage)−(Num_Of_Clicks*Bid_Cost_Per_Click)

The Black Box optimization algorithm objective function is unknown, thus the Black Box optimization algorithm treats the objective function as a random function and places a prior over it. The prior captures the beliefs about the behavior of the function; note that in Bayesian statistical inference technology, a prior or “prior probability distribution” of an unknown quantity is the probability distribution that would express beliefs about this quantity before certain data has been taken into account. Once evaluations/trials are gathered, the prior is updated to form the posterior distribution over the objective function. The posterior distribution is then used to construct an acquisition function to determine the next query point of Bid and Markup. For example, using Bayesian Optimization, the algorithm is fed with the set of preliminary trial parameters (bid, markup/commission) and the trial results (profit) and then the optimization algorithm proposes a new set of bid and markup/commission for the next time period. This process runs iteratively, minimizing the bid and maximizing the markup/commission for the average booking per each entity such as a hotel.

Wikipedia lists software tools for Bayesian optimization e.g. “GPyOpt, Python open-source library for Bayesian Optimization based on GPy.
Bayesopt, an efficient implementation in C/C++ with support for Python, Matlab and Octave.
Spearmint, a Python implementation focused on parallel and cluster computing.
Hyperopt, a Python implementation for hyperparameter optimization.
SMAC, a Java implementation of random-forest-based Bayesian optimization for general algorithm configuration.
pybo, a Python implementation of modular Bayesian optimization.
Bayesopt.m, a Matlab implementation of Bayesian optimization with or without constraints.
MOE MOE is a Python C++/CUDA implementation of Bayesian Global Optimization using Gaussian Processes.
SigOpt SigOpt offers Bayesian Global Optimization as a SaaS service focused on enterprise use cases.
Metaopt, a Python implementation of hyperparameter optimization focused on parallel and cluster computing.
Mind Foundry OPTaaS offers Bayesian Global Optimization via web-services with flexible parameter constraints.”

It is appreciated that Reinforcement Learning or Genetic Algorithms (for example) may be used as an alternative to Bayesian Optimization.

Reinforcement Learning based Bid Optimization
In this method or mode or option, the server may utilize a reinforcement learning algorithm in order to control the bid and the markup. For example, the Q-Learning algorithm may be used as follows:
A State is defined as a pair of the current Bid and Markup values (additional features may be added).
An Action may be defined as Increment/Decrement of the control parameters: Inc_Bid_By_5%, Dec_Bid_By_5%, Inc_Bid_By_0%, Dec_Bid_By_10%, Inc_Markup_By_Dec_Markup_By_5%, do nothing (e.g. increment by zero percent), etc.
While running through the iterations, the Q-Learning algorithm will find an optimal action-selection policy for any given Markov decision process (MDP).
Wikipedia explains that reinforcement may employ a Markov decision process model including a set of environment and agent states, S; a set of actions, A, of the agent, and rules that describe what the agent observes. “The observation typically involves the scalar, immediate reward associated with the last transition. A reinforcement learning agent typically interacts with its environment in discrete time steps. At each time t, the agent receives an observation, which typically includes the reward, then chooses an action from the set of available actions, which is subsequently sent to the environment. The environment moves to a new state and the reward associated with the transition is determined. The goal of a reinforcement learning agent is to collect as much reward as possible. The agent may (possibly randomly) choose any action as a function of the history”.

One reinforcement learning technique is Q-learning. In each value iteration update the following Q-Learning step may be executed e.g. as shown in FIG. 5a, where sₜ represents the given state (bid, markup) at time t and aₜ represents the action taken at time t.

As parameters: Alpha represents the learning rate and Gamma represents the discount factor—where low values lead to considering current rewards and high values lead to long term high reward.
The Reward r₁ of the last iteration is based on a formula that represents the success rate of this iteration, such as the profit, which may be computed, as shown in FIG. 5b, by: (Num_Of_Clicks Conversion_Rate Average_Booking_Value* Commission_Percentage) Num_Of_Clicks* Bid_Cost_Per_Click).

It is appreciated that he above techniques are generally useful for optimizing interaction of business end-users with price comparison websites e.g. http://corporate.zapgroup.co.il/en/zap-price-comparisons and bidding for ads appearance in search engines as in Google AdWords bidding system. (https://ads.google.com/home/).

Some price comparison websites determine which partner websites (which business end-users' websites) to display, responsive to a query about product or service p, depending not only on a first consideration of how attractive is the partner website's price for product or service p, but also depending on a second consideration of how profitable are various partner websites which supply product or service p, for the price comparison website. Typically the partner website communicates to the price comparison website, from time to time, a bid and a markup. If a partner sends low markup, the partner's website will be prioritized, in displays to end-users, relative to other partners which send in higher markups, however, if a partner bids low, compared to other partners which bid higher, the partner's website will be prioritized low, in displays to end-users, relative to the other partners which bid higher. It is appreciated that each partner website may have an API vis a vis a GDS. The extent and manner in which the price comparison website's server's algorithm factors in the two considerations above to preserve the price comparison website's good name and also its profitability, typically remains proprietary, hence is not known to the partners' websites.

It is appreciated that any suitable target function may be employed for optimizing interaction with price comparison websites using the described optimizations. For example, total profit (which may be positive, zero or negative) for the business end-user thanks to the price comparison website, per time period, is one possible target function, however other target functions may factor in, say, number of transactions for the business end user, per time period e.g. per month, via the price comparison website, or even a measure of the business end-user's extent of exposure on the price comparison website, over the month or other time-period.

It is appreciated that whereas initially a black box algorithm may randomly select values for bids and markup, with time, the black box algorithm typically suggests values for bid and/or markup, until eventually a maximal or best set of bid and markup are arrived at, given certain conditions e.g. assuming there are no changes in the price comparison website's internal algorithm, for example.

According to Wikipedia, “Reinforcement learning involves an agent, a set of states and a set of actions per state. By performing an action, the agent transitions from state to state. Executing an action in a specific state provides the agent with a reward”. The agent may be the business end-user, the states may each include a bid and/or a markup provided by the business end-user to the price comparison website. Any suitable target function, e.g. as described above, may be used to compute the reward. Typically, if a q-learning algorithm is used, initial q values are zero; thus if at least one positive non-initial q value already exists, for a given action and a given state, the highest valued action may be selected, whereas if all non-initial q values are negative, the algorithm may simply randomly select an action from among those whose q values are zero. Eventually, the algorithm arrives at a state e.g. specific bid and markup, which are optimal e.g. exceed a predetermined criterion of optimality e.g. threshold reward, or when continued operation of the algorithm hardly improves the state's profitability or target function value, or any other stopping criterion.

It is appreciated that instead of using optimization algorithms or learning, the business end-user's server may simply store a pre-built table e.g. that of FIG. 5c whose cell contents were filled using the formula of FIG. 5d. For example, as shown in the table of FIG. 5c, given 100 clicks, abv=250 USD and conversation rate of 2.5%, plugging a bid of 1.3 USD and markup of 30% into the formula of FIG. 5d yields a value of 44% as seen in the lower right-hand corner of the table of FIG. 5c. Note that the top-right diagonal half of the table of FIG. 5c has positive values, whereas the bottom-left diagonal half of the table of FIG. 5c has negative values. The conversion rate may be determined e.g. depending on data collected by the business end-user's website e.g. if the website server keeps a log or database of transactions that occurred through the website.

It is appreciated that the business end-user may not necessarily select the bid and markup corresponding to the largest positive value in the table of FIG. 5c e.g. may or may not select, in the illustrated example, the top right hand cell whose value is 1775%, corresponding to a 0.10 USD bill and a markup of 30%.

Feeding Risk Level to Optimization Algorithms: Algorithm parameters may be tuned according to a computed risk level—where the risk is bound to the profit levels—such that low risk means high expected profit and high risk means low expected profit or high loss. Risk margin computation is now described, with reference to FIG. 5c which is a sample table depicting different Bids (Rows) and Markup percentages (Columns) for a given assumption of number of Clicks, Average Booking Value, and Conversion Rate. Each cell in the table may be computed as shown in FIG. 5a, by computing Conversion_rate*#clicks*AverageBookingValue*CommissionPercentage—#Clicks* Bid_CPC and dividing by #Clicks*Bid_CPC.

AverageBookingValue (ABV) may be extracted from historical transactions as saved in a database or log of the website or estimated by published quotes of the specific entity (hotel).

Conversion Rate and he estimated by historical transactions, or industry rule of thumb, or evaluated per hotel.
Number of clicks does not affect the total result since the percentage of profit may be computed from the expense on clicks.
Thus, using this table, it is possible to select a bid and set a commission percentage for a given hotel, such that the risk of loss is reduced.
In addition, upon optimizing only a single parameter (such as the bid CPC) the required commission for profit may be extracted from that table, or, upon optimizing the commission, the required bid CPC may be extracted from the table.

Any suitable optimization technology may be used for optimizations described herein such as but not limited to those described herein, and/or derivative-free optimization techniques.

It is appreciated that any of the embodiments herein, but need not necessarily be, implemented as a web-service.

It is appreciated that terminology such as“mandatory”, “required”, “need” and “must” refer to implementation choices made within the context of a particular implementation or application described herewithin for clarity and are not intended to be limiting since in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order e.g. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and b) outputting the solution.

The system may, if desired, be implemented as a web-based system employing software, computers, routers and telecommunications equipment as appropriate.

Any suitable deployment may be employed to provide functionalities software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices, such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true and never by determinations that x is false.

Features of the present invention, including operations which are described in the context of separate embodiments, may also be provided in combination in a single embodiment. For example, a system embodiment is intended to include a corresponding process embodiment, and vice versa. Also, each system embodiment is intended to include a server-centered “view” client centered “view”, or “view” from any other node of the system, of the entire functionality of the system , computer-readable medium, apparatus, including only those functionalities performed at that server or client or node. Features may also be combined with features known in the art and particularly, although not limited to, those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated. or described herein.

Devices, apparatus or systems shown coupled in any of the drawings may in fact be integrated into a single platform in certain embodiments or may be coupled via any appropriate wired or wireless coupling such as but not limited to optical fiber, Ethernet. Wireless LAN, HomePNA, power line communication, cell phone, Smart Phone (e.g. iPhone), Tablet, Laptop, PDA, Blackberry CPRS, Satellite including GPS, or other mobile delivery. It is appreciated that in the description and drawings shown and described herein, functionalities described or illustrated as systems and sub-units thereof may also be provided as methods d operations therewithin, and functionalities described or illustrated as methods and operations therewithin may also be provided as systems and sub-units thereof. The scale used to illustrate various elements in the drawings is merely exemplary and/or appropriate for clarity of presentation and is not intended to be limiting.

1. A method for managing communications with suppliers; the method comprising:
for at least one user's request of a vacation deal using a processor to perform:
retrieving a list of suppliers that support the vacation deal request
predicting an optimal supplier for the user's request
sending the request to the optimal supplier predicted by said predicting; and
receiving the request result.

2. A method according to claim 1, wherein said predicting uses a regular classification algorithm.

3. A method according to claim 1, wherein the method is used for managing communications with suppliers for split-based deals; the method also comprising, for at least one user's request of a vacation deal, decomposing the request to multiple optional splits, and wherein said retrieving is performed per each split part, the method also comprising predicting an optimal split index for the said user request, e.g. using a regular classification algorithm, and wherein said predicting the optimal supplier is performed for each of the split parts.

4. A method according to claim 3, where said predicting the optimal supplier uses a probability classification algorithm and then iteratively finds, per each split part, the optimal suppler of that split.

5. A method according to claim 1, where a package deal is composed of multiple deal ingredients (such as hotel, flight, car rental) and wherein said retrieving, predicting, sending and receiving are performed per each deal ingredient.

6. A method according to claim 1, where a package deal contains flights utilizing the flight optimization methods mentioned in this document as Methods for Flight Price Optimization.

7. A method according to claim 1, wherein said predicting uses a Probabilistic Classification algorithm, the method also comprising evaluating whether the request result is attractive, and, if not, continuing or repeating the method with the next predicted supplier until an attractive deal is found, or another policy condition has been met.

8. A method according to claim 3, wherein said predicting the optimal supplier uses a regular classification algorithm.

9. A method according to claim 4, wherein said predicting the optimal supplier iteratively finds, per each split part, the optimal supplier of that split by iteratively using a Probabilistic Classification algorithm for predicting an optimal supplier and, wherein, in each iteration, if the request result is not attractive, the method is continued or repeated with the next predicted supplier until an attractive deal is found, or another policy condition has been met.

10. A method according to claim 7, where a package deal composed of multiple deal ingredients (such as hotel, flight, car rental) and wherein said retrieving, predicting, sending and receiving are performed per each deal ingredient.

11. A system for managing communications with suppliers, comprising:
a processor operative to perform, for at least one user's request of a vacation deal:
i. retrieving a list of suppliers that support the vacation deal request
ii. predicting an optimal supplier for the user's request
iii. sending the request to the predicted optimal supplier
iv. receiving the request result.

12. A computer program product, comprising a non-transitory tangible computer readable medium having computer readable program code embodied therein, said computer readable program code adapted to be executed to implement a method for managing communications with suppliers, comprising:
for at least one user's request of a vacation deal using a processor to perform:
retrieving a list of suppliers that support the vacation deal request
predicting an optimal supplier for the user's request
sending the request to the optimal supplier predicted by said predicting; and
receiving the request result.

13. A method according to claim 1, which is applied to managing communications with suppliers for split-based deals; the method also comprising, for at least one user's request of a vacation deal, decomposing the request to multiple optional splits, and wherein said retrieving is performed per each split part, the method also comprising predicting an optimal set of (split index, supplier of 1^{st} split part, supplier of 2^{nd} split part) for the said user request.

14. The method according to claim 13, wherein the predicting of the optimal set of (split index, supplier of 1^{st} split part, supplier of 2^{nd} split part) for the said user request comprises using a classification algorithm.
